(19) United States
(12) Patent Application Publication
(10) Pub. No.: US 2017/0032299 A1
(43) Pub. Date: Feb. 2, 2017

(54) Web-based System and Method for Facilitating Off-loading of Design Requirements to a Supplier

(71) Applicant: The Boeing Company, Chicago, IL (US)

(72) Inventors: Neil K. Lichty, Snohomish, WA (US); David W. Patterson, Everett, WA (US)

(21) Appl. No.: 14/811,315

(22) Filed: Jul. 28, 2015

(51) Int. Cl. G06Q 10/06; G06F 17/30

(52) U.S. Cl. CPC G06Q 10/06313; G06F 17/30876

(57) ABSTRACT

A method is provided of operating a web-based system to facilitate interactive exchange and modification of design requirements within a design requirements package between an enterprise and a supplier to the enterprise. The method comprises storing, by the enterprise, a design requirements package in an enterprise database. The method further comprises electronically by a processor, transmitting a message from the enterprise to the supplier to notify the supplier of the availability of the design requirements package stored in the enterprise database. The method also comprises accessing, by the enterprise, the design requirements package and supplier deliverables to view modifications made by the supplier to the package after the supplier has been notified of the availability of the package and has accessed the package in the enterprise database and made modifications to the package.

### FIELD

The present invention relates to design requirements off-loading processes, and is particularly directed to a web-based system and method for facilitating off-loading of design requirements to a supplier.

### BACKGROUND

A typical design requirements off-loading process within an enterprise usually involves engineering designers of the enterprise, procurement agents of the enterprise, and contracted suppliers from outside the enterprise. The engineering designers define design requirements which are communicated through the procurement agents to the contracted suppliers so that the contracted suppliers can design and supply the parts to the originating enterprise. A contracted supplier may be subject to a development assurance (DA) procedure in which the flow down of design requirements to the supplier and decomposition of the design requirements at the supplier's facilities need to be visible so as to be in compliance with industry standards, for example.

Workflows of known design requirements off-loading processes are minimal and manually-intensive. Workflow is manually managed individually according to knowledge and undefined roles within the enterprise, resulting in fragmented tasks and design elements which are either not planned or forgotten entirely. Also, workflow is manually checked within the enterprise, resulting in non-consistent checking of design requirements and thereby errors in design requirements which are propagated to the supplier.

Moreover, in workflows of known design requirements off-loading processes, requirements validation, qualification methods and verification are manually authored and associated to design requirements. This manual gathering of data is labor-intensive with many redundancies. It would be desirable to provide a system and method which overcome drawbacks in establishing validation, qualification methods, and verification supporting design requirements off-loading processes.

Further, each distribution of a design requirements package to a supplier is manually handled individually within the enterprise. Manual distribution of the design requirements package to the supplier is slow, lacks configuration controls, and lacks interaction between the engineering designers who are within the enterprise and the suppliers who are outside of the enterprise. Accordingly, visibility of flow down of design requirements to the supplier and visibility of decomposition of the design requirements at the supplier's facilities are also lacking.

Moreover, in workflows of known design requirements off-loading processes, design requirements metrics and measures need to be manually gathered for purpose of performance report generation. This manual gathering of data is both difficult and labor-intensive. It would be desirable to provide a system and method which overcome drawbacks in workflows of known design requirements off-loading processes.

### SUMMARY

In one aspect, a method is provided of operating a web-based system to facilitate interactive exchange and modification of design requirements within a design requirements package between an enterprise and a supplier to the enterprise. The method comprises storing, by the enterprise, a design requirements package in an enterprise database, electronically by a processor, transmitting a message from the enterprise to the supplier to notify the supplier of the availability of the design requirements package stored in the enterprise database, and accessing, by the enterprise, the design requirements package and supplier deliverables to view modifications made by the supplier to the package after the supplier has been notified of the availability of the package and has accessed the package in the enterprise database and made modifications to the package.

In another aspect, a method is provided of operating a web-based system to facilitate a design engineer and a procurement agent of an enterprise to provide a completed original design requirements package to be off-loaded to a contracted supplier to the enterprise. The method comprises creating, by the design engineer, original design requirements, electronically by a processor, recognizing if required data elements are missing from the original design requirements created by the design engineer, electronically by a processor, interactively directing the design engineer with process steps needed to provide any required data element missing from the original design requirements and thereby to provide a completed original design requirements package, storing the completed original design requirements package in an enterprise database, and reviewing, by the procurement agent, the completed original design requirements package before the contracted supplier is notified of the availability of the completed original design requirements package to allow the contracted supplier to access the completed original design requirements package stored in the enterprise database.

In yet another aspect, a web-based system is provided for facilitating an enterprise to manage design requirements while maintaining computer sensibility of the design requirements during a design requirements off-loading process from the enterprise to a supplier. The web-based system comprises an enterprise supplier requirements exchange (SRX) database for storing SRX data, an executable enterprise SRX application, and an enterprise host server including a processor configured to execute the enterprise SRX application to enable the supplier to interactively access and modify the SRX data stored in the enterprise SRX database and thereby to facilitate the enterprise in managing the design requirements while maintaining computer sensibility of the design requirements during the design requirements off-loading process.

Other aspects will become apparent from the following detailed description, the accompanying drawings and the appended claims.

### BRIEF DESCRIPTION OF THE DRAWINGS

FIG. 1 is a block diagram of a web-based system for facilitating a design requirements off-loading process in accordance with an embodiment.

FIGS. 2A-2C (referred to collectively as FIG. 2) are an enlarged view of a portion of the block diagram of FIG. 1, and showing details of gated workflow processes in FIG. 1.

FIGS. 3A-3E (referred to collectively as FIG. 3) are enlarged views of the gated workflow processes shown in FIG. 2, and showing additional details for the gated workflow processes.

FIG. 4 is an enlarged view of the gated workflow processes shown in FIG. 2, and showing additional details for the gated workflow processes.

FIG. 5 is an enlarged view of the gated workflow processes shown in FIG. 2, and showing additional details for the gated workflow processes.

FIG. 6 is an enlarged view of the gated workflow processes shown in FIG. 2, and showing additional details for the gated workflow processes.

FIGS. 7A-7B (referred to collectively as FIG. 7) is an enlarged view of the gated workflow processes shown in FIG. 2, and showing additional details for the gated workflow processes.

FIGS. 8A-8B (referred to collectively as FIG. 8) is an enlarged view of the gated workflow processes shown in FIG. 2, and showing additional details for the gated workflow processes.

FIGS. 9A-9B (referred to collectively as FIG. 9) is an enlarged view of the gated workflow processes shown in FIG. 2, and showing additional details for the gated workflow processes.

FIGS. 10A-10B (referred to collectively as FIG. 10) is an enlarged view of the gated workflow processes shown in FIG. 2, and showing additional details for the gated workflow processes.

FIG. 11 is a workflow diagram of a known design requirements off-loading process.

FIG. 12 is a diagram showing a comparison of the known design requirements off-loading process of FIG. 11 and a design requirements off-loading process in accordance with an embodiment.

FIG. 13 is a workflow diagram showing an end-to-end workflow across the gated workflow processes shown in FIGS. 3-10.

FIG. 14 is an enlarged view of portions of the end-to-end workflow shown in FIG. 13.

FIG. 15 is an enlarged view of portions of the end-to-end workflow shown in FIG. 13.

FIG. 16 is an enlarged view of portions of the end-to-end workflow shown in FIG. 13.

FIG. 17 is an enlarged view of portions of the end-to-end workflow shown in FIG. 13.

FIG. 18 is an enlarged view of portions of the end-to-end workflow shown in FIG. 13.

FIG. 19 is an enlarged view of portions of the end-to-end workflow shown in FIG. 13.

FIG. 20 is an enlarged view of portions of the end-to-end workflow shown in FIG. 13.

FIG. 21 is an enlarged view of portions of the end-to-end workflow shown in FIG. 13.

### DETAILED DESCRIPTION

The present invention is directed to a web-based system and method for facilitating off-loading of design requirements to a supplier. The specific construction of the web-based system and the industry in which the system is implemented may vary. It is to be understood that the disclosure below provides a number of embodiments or examples for implementing different features of various embodiments. Specific examples of components and arrangements are described to simplify the present disclosure. These are merely examples and are not intended to be limiting.

By way of example, the disclosure below describes a web-based system and method implemented by the Boeing Corporation for off-loading of design requirements for airplane parts in compliance with FAA regulations. The following is a list of acronyms used in the detailed description below:

| ACRONYM | NAME | DESCRIPTION |
|---|---|---|
| AA | Administrative Agreement | Defines how suppliers meet |
| | | non-technical requirements |
| ACA | Airplane Configuration | |
| | Analyst | |
| AR | Authorized Representative | FAA designated individual |
| CATIA | name of software system | A Computer Aided Design |
| | | system used for 3-D |
| | | engineering design |
| | | models and drawings |
| CMA | Configuration Management | |
| | Analyst | |
| CRN | Contracts Record Number | |
| CSDT | Customer & Supplier Data | |
| | Transmittal | |
| DE | Design Engineer | |
| DOORS ® | Dynamic Object-Oriented | An IBM ® software |
| | Requirements System | tool used for analysis of |
| | | requirements |
| ENOVIA ® | name of a software system | A data management system |
| | | used for product lifecycle |
| | | management |
| FAA | Federal Aviation | |
| | Administration | |
| ICD | Interface Control Drawing | |
| LCPT | Life Cycle Product Team | |
| MBD | Model Based Definition | |
| ME | Manufacturing Engineer | |
| PA | Procurement Agent | |
| PA MGR | Procurement Agent Manager | |
| PDM ® | name of software system | A data management system |
| | | used for product lifecycle |
| | | management |
| PIA | Proprietary Information | |
| | Agreement | |
| PIMS | Parts Information | |
| | Management System | |
| ProE | name of software system | A Computer Aided Design |
| | | system used for 3-D |
| | | engineering design |
| | | models and drawings |
| RAC | Request Authorization for | |
| | Change | |
| REDARS | Reference Engineering Data | |
| | Automated Retrieval System | |
| RFI | Request for Information | |
| RFP | Request for Proposal | |
| RFQ | Request for Quotation | |
| ROC | Resolution of Comments | |
| SCD | Specification Control Drawing | |
| SCN | Supplier Change Notification | |
| SDRL | Supplier Data | List of deliverables required |
| | Requirements List | from the supplier |
| SLATE ® | name of a software system | A software tool used for |
| | | allocation of requirements |
| SM | Supplier Management | |
| SME | Subject Matter Expert | |
| SOAP | Simple Object Access | |
| | Protocol | |
| SRX | Supplier Requirements | |
| | eXchange | |
| STRESS | Stress Engineering | |
| WA | Washington | |
| XML | eXtensible Markup Language | |

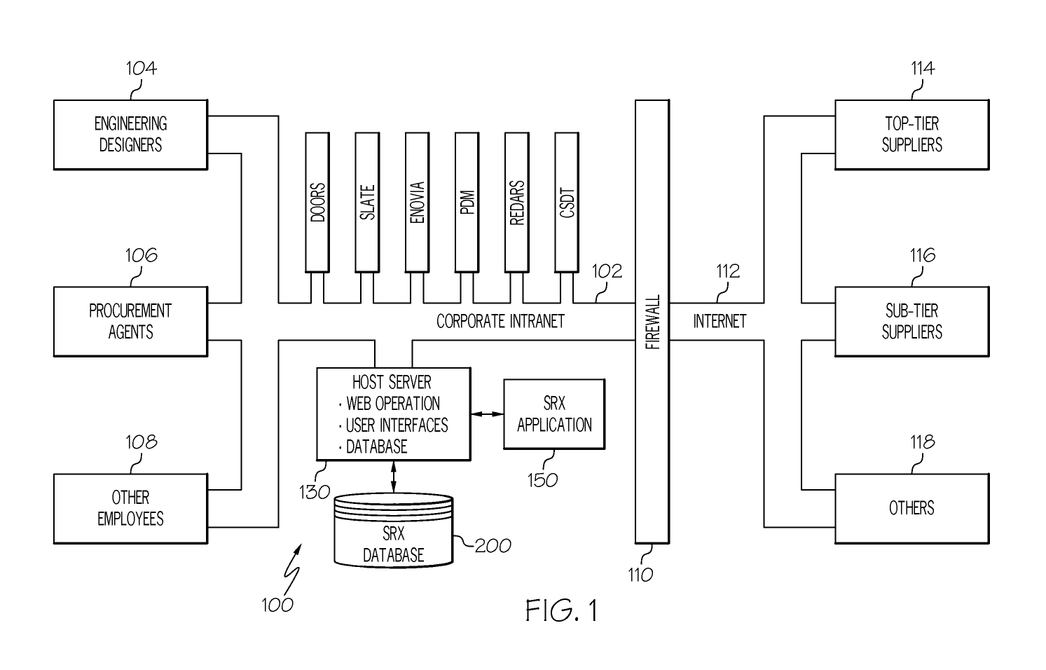

Referring to FIG. 1, a block diagram of a web-based enterprise software system 100 is shown. The web-based system 100 is suitable for implementing design requirements off-loading processes in accordance with disclosed embodiments. The web-based system 100 communicates via a corporate intranet 102 with engineering designers 104, procurement agents 106, and other employees 108 of the enterprise. The corporate intranet 102 communicates through a firewall 110 with access security to the Internet 112. The corporate intranet 102 may comprise a web-based protocol, such as SOAP, to support exchange of structured information on the corporate intranet 102. SOAP may use XML for its message format. Specifications for SOAP architecture and specifications for XML are known and, therefore, will not be described.

The corporate intranet 102 and the Internet 112 supports communication between internal resources (i.e., the web-based system 100, the engineering designers 104, the procurement agents 106, and the other employees 108 of the enterprise, for examples) and external resources including top-tier suppliers 114, sub-tier suppliers 116, and others 118. The top-tier suppliers 114 and the sub-tier suppliers 116 may comprise contracted suppliers, and the others 118 may comprise third-party partners, internal partners, or mobile employees of the enterprise, for examples.

In accordance with an embodiment, the web-based system 100 comprises a host server 130 which communicates via the corporate intranet 102 with the engineering designers 104, the procurement agents 106, and the other employees 108, and via the corporate intranet 102 and the Internet 112 with the top-tier suppliers 114, the sub-tier suppliers 116, and the others 118 external to the enterprise. The host server 130 is a web-based server which communicates with a database 200 which may comprise an XML database. The host server 130 accesses and stores SRX data in the database 200. The SRX database 200 and the SRX data stored therein will be described in detail later.

The host server 130 includes an electronic processor which is configured to execute a SRX application 150 to facilitate a design requirements off-loading process in accordance with an embodiment as will be described below. More specifically, the electronic processor of the host processor 130 executes the SRX application 150 to access and store SRX data in the SRX database 200 as needed to support web operation and user interfaces (e.g., the web-based user interfaces of the engineering designers 104, the procurement agents 106, and the suppliers 114, 116) used in the design requirements off-loading process.

The electronic processor of the host server 130 may also execute the SRX application 150 to support interfaces to other data systems which are connected to the corporate intranet 102. For examples, as shown in FIG. 1, the SRX application 150 may support any combination of interfaces to a CSDT data system, a REDARS data system, a PDM data system, an ENOVIA data system, a SLATE data system, and a DOORS data system. It is conceivable that the SRX application may support any combination of other interfaces to other data systems. The SRX application 150 supports interfaces to other data systems to enable the SRX application 150 to natively use the data from these other data systems.

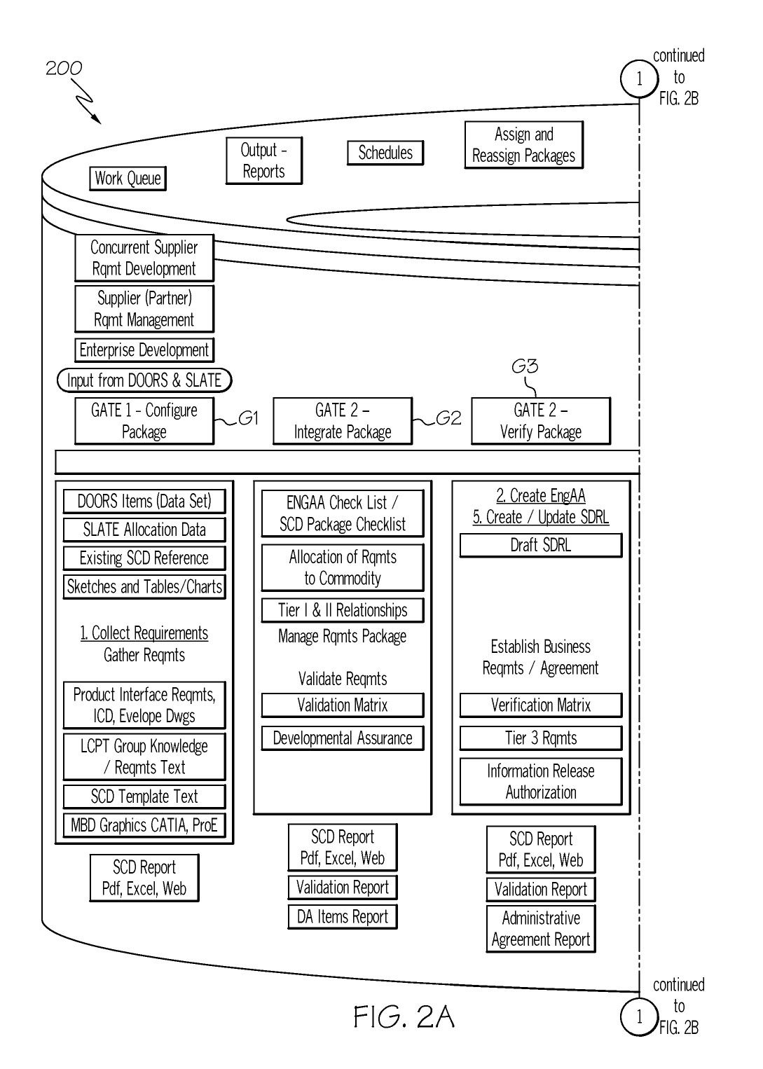

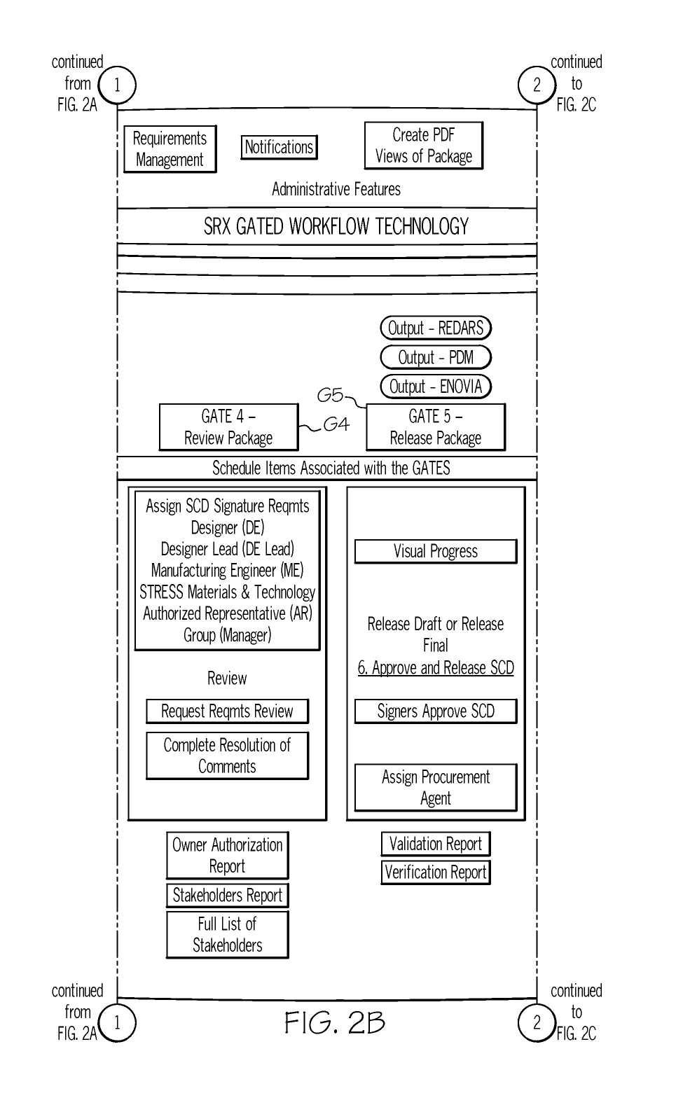

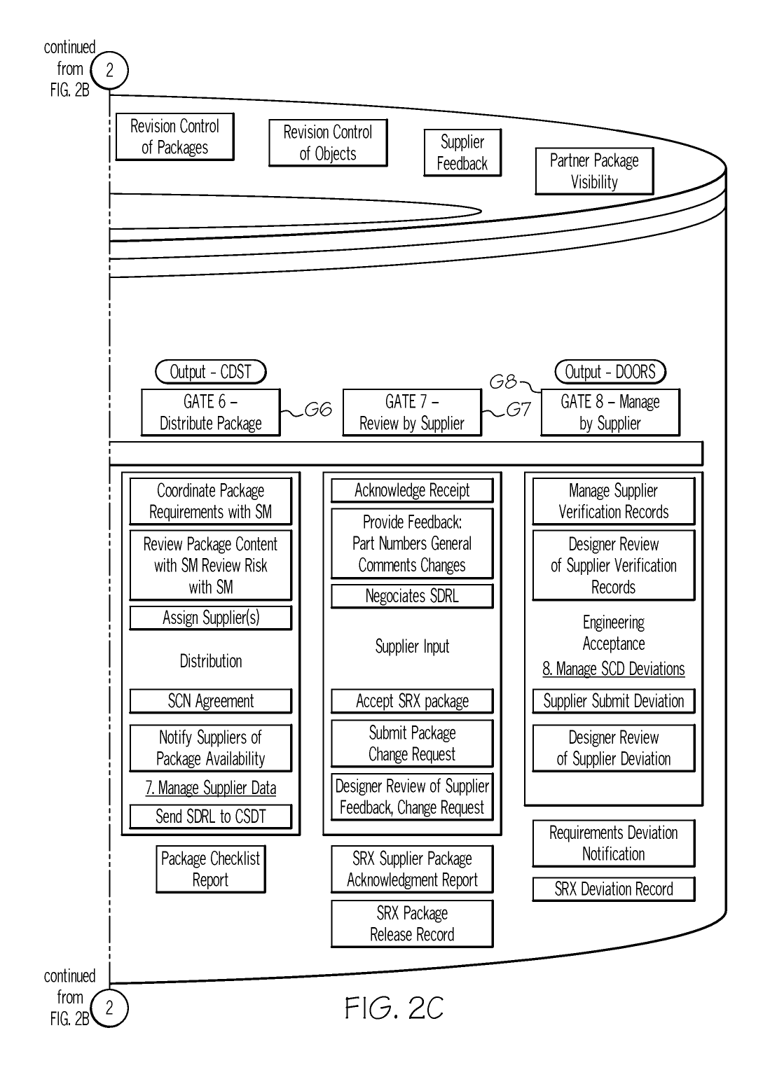

Referring to FIG. 2, the SRX database 200 comprises a web-enabled relational database which supports gated workflow technology. As shown in the example embodiment of FIG. 2, there are eight (8) gated workflow processes designated as Gate 1 (G1), Gate 2 (G2), Gate 3 (G3), Gate 4 (G4), Gate 5 (G5), Gate 6 (G6), Gate 7 (G7), and Gate 8 (G8). Each gate may have input data from or output data to other data systems. Any input data or output data which may be associated with a gate is shown above that particular gate in FIG. 2.

Each gate also has a number of schedule items of the design requirements off-loading process associated with that particular gate. The schedule items of the design requirements off-loading process associated with a gate is shown below that particular gate in FIG. 2. Moreover, each gate has a number of reports (i.e., design requirements metrics and measures) associated with that particular gate. The reports associated with a gate are shown below the schedule items associated with that particular gate.

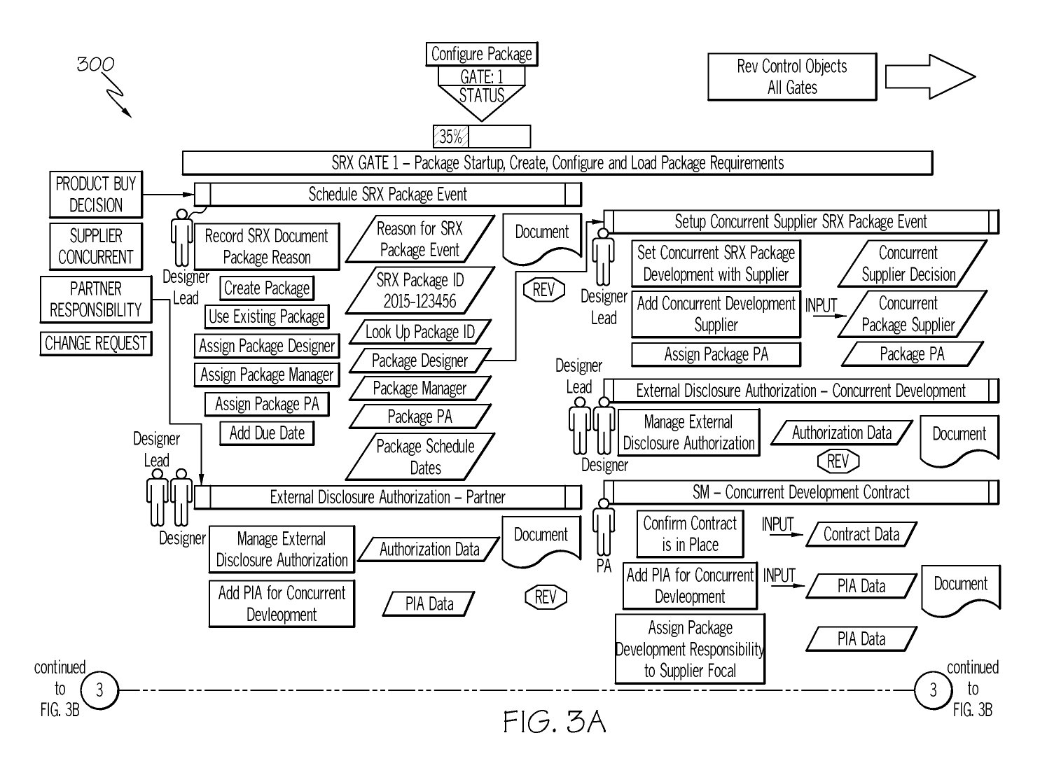

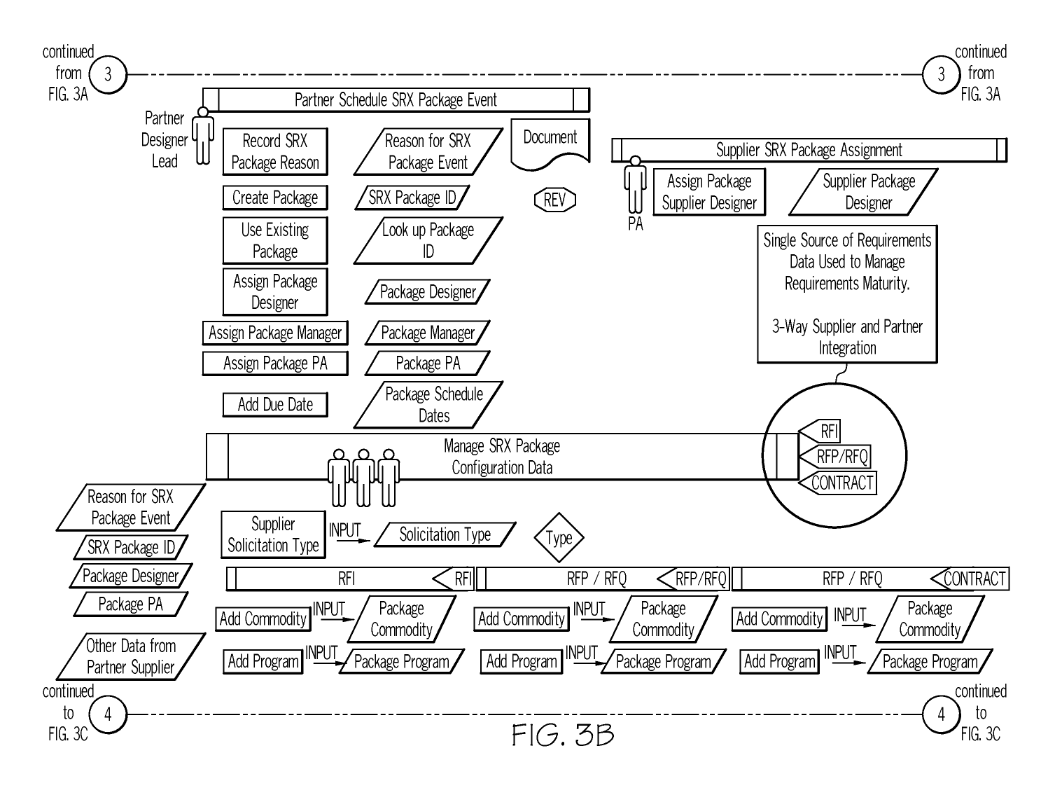

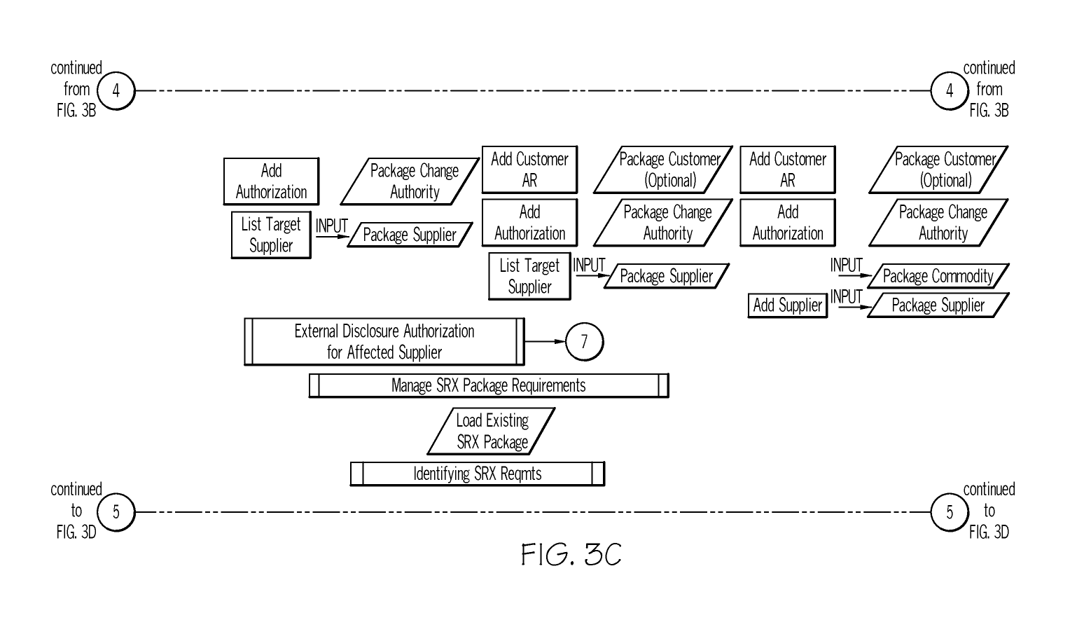

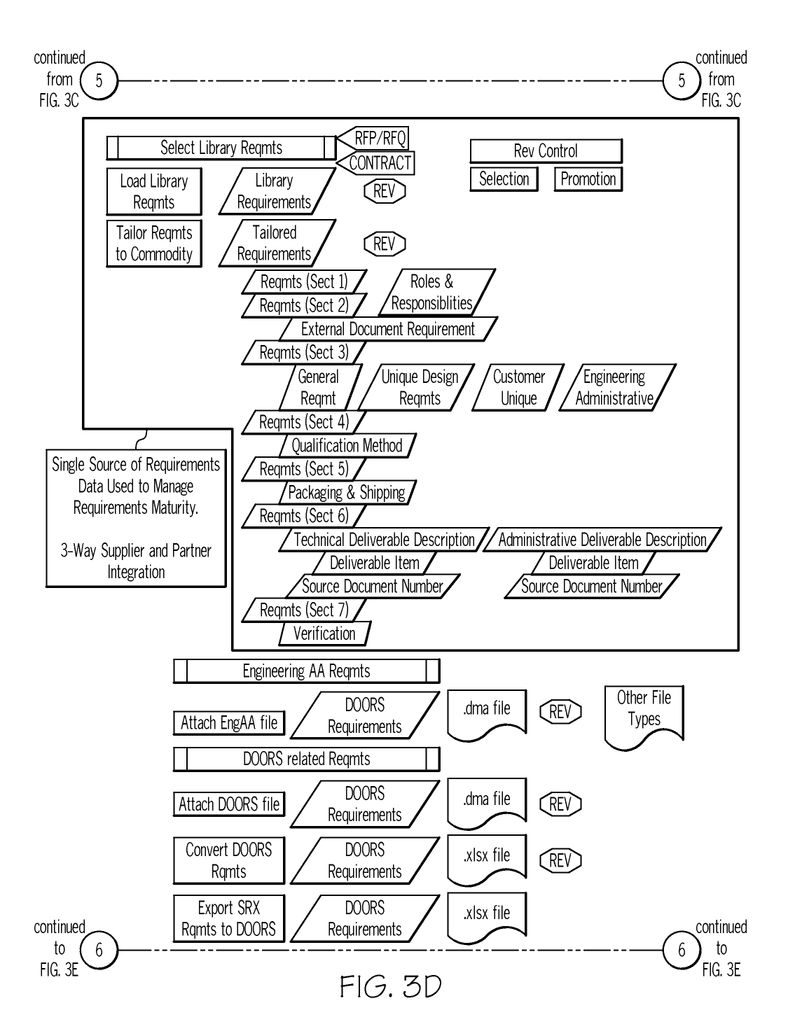

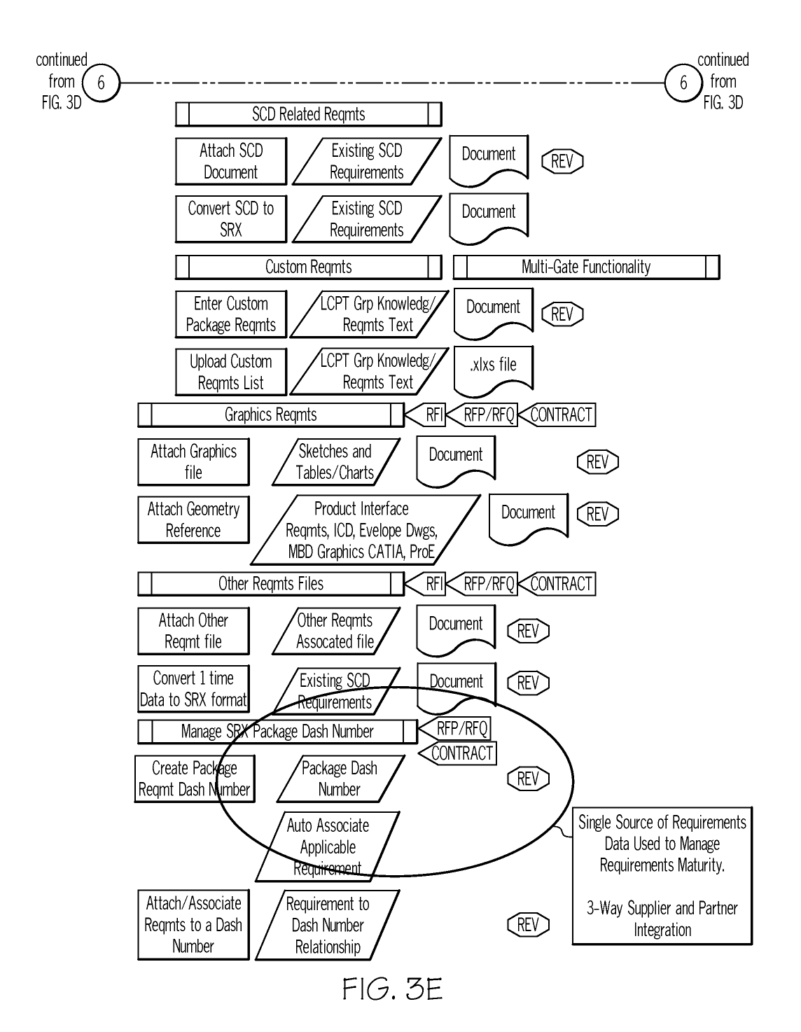

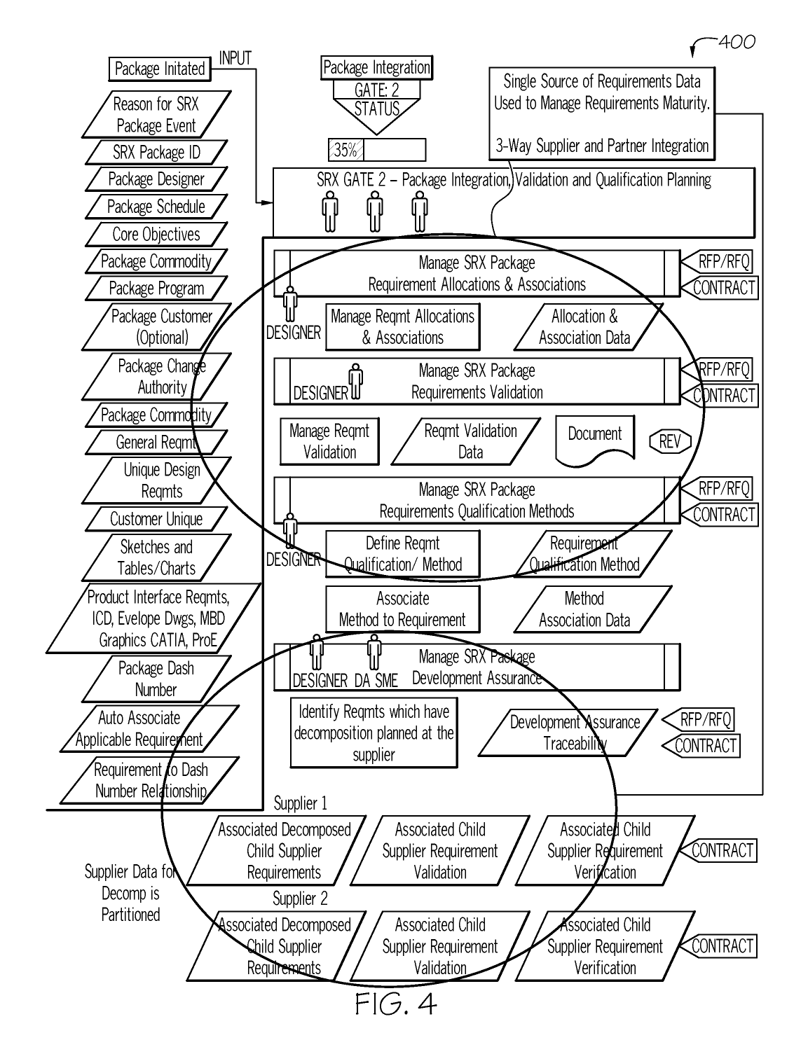

Workflow process steps contained in each of gates G1, G2, G3, G4, G5, G6, G7, and G8 are shown in FIGS. 3-10, respectively. In FIG. 3 for gate G1, a vertical array of rectangular blocks is shown along the left side of FIG. 1. The vertical array of rectangular blocks shown in FIG. 1 indicates the initiators of the SRX process. These initiators are from outside of the SRX system 100. In each of FIGS. 4-10 for gates G2, G3, G4, G5, G6, G7, and G8, respectively, a vertical array of trapezoidal blocks is shown along the left side of the corresponding figure. The vertical array of trapezoidal blocks shown in each of FIGS. 4-10 indicates data entities which have been created in workflow processes of a previous gate and are available for processing in the workflow processes of the current gate.

Referring to gated workflow process 300 shown in FIG. 3, gate G1 is directed to Package Startup, Create, Configure and Load Package Requirements. Initial SRX activities accomplished by gate G1 allow use of the tool to manage Package Startup, Create, Configure and Load Package Requirements. This step is the foundation of the requirements packaging which feeds all of the supporting steps in SRX.

Referring to gated workflow process 400 shown in FIG. 4, gate G2 is directed to Package Integration, Validation and Qualification Planning. This activity sets the bar for industry standards for requirements Package Integration, Validation and Qualification Planning. These elements of the package create a traceable set of qualitative data for the package requirements which enable the users and tool to elevate the requirements maturity.

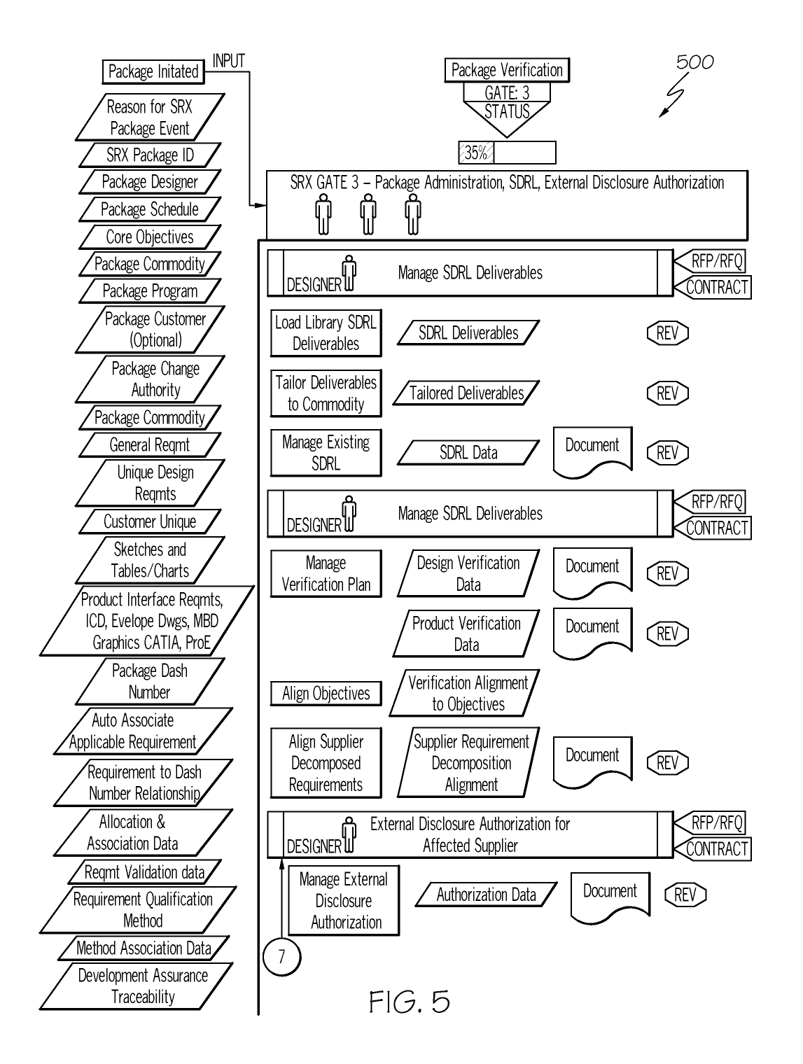

Referring to gated workflow process 500 shown in FIG. 5, gate G3 is directed to Package Administration, SDRL and External Data Release Authority. The elements in gate G3 support verification of the requirements package which leads to supplier submittal of contract data deliverables. These deliverables are the key to product design compliance to the package requirements.

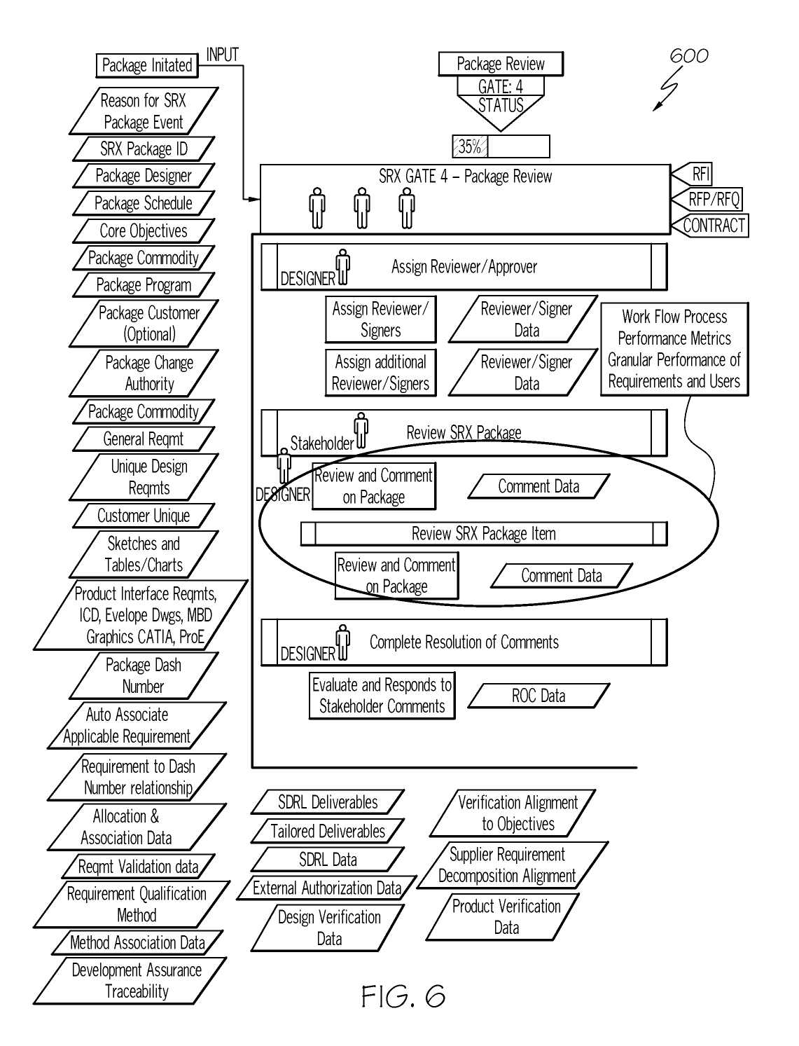

Referring to gated workflow process 600 shown in FIG. 6, gate G4 is directed to Stakeholder and Approver Package Review. Gate G4 takes advantage of the relational aspects of the stakeholders to the package requirements. The package owner gets a significant advantage in the auto load of the stakeholders for review and approval, eliminating gaps in requirement and product quality.

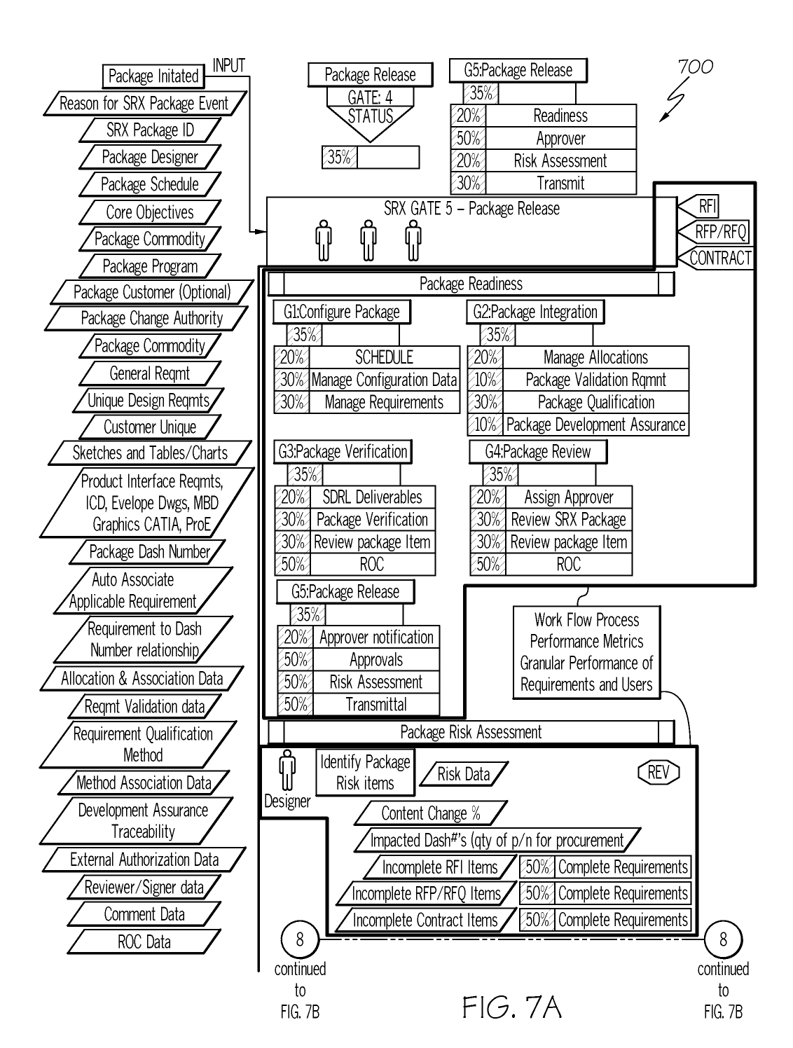

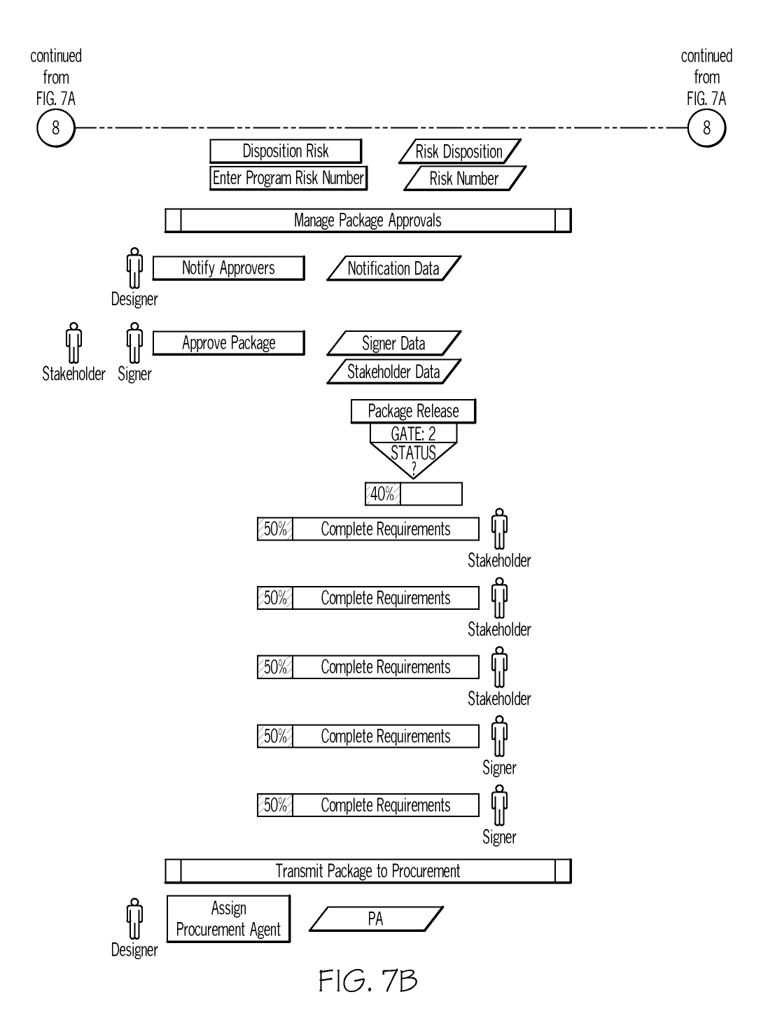

Referring to gated workflow process 700 shown in FIG. 7, gate G5 is directed to Package Release. Advantages excel over typical software behaviors by integrating advanced metrics and performance visibility during release promotion of the package. These qualitative measures target business risk mitigation and control advancement of the package through risk controls.

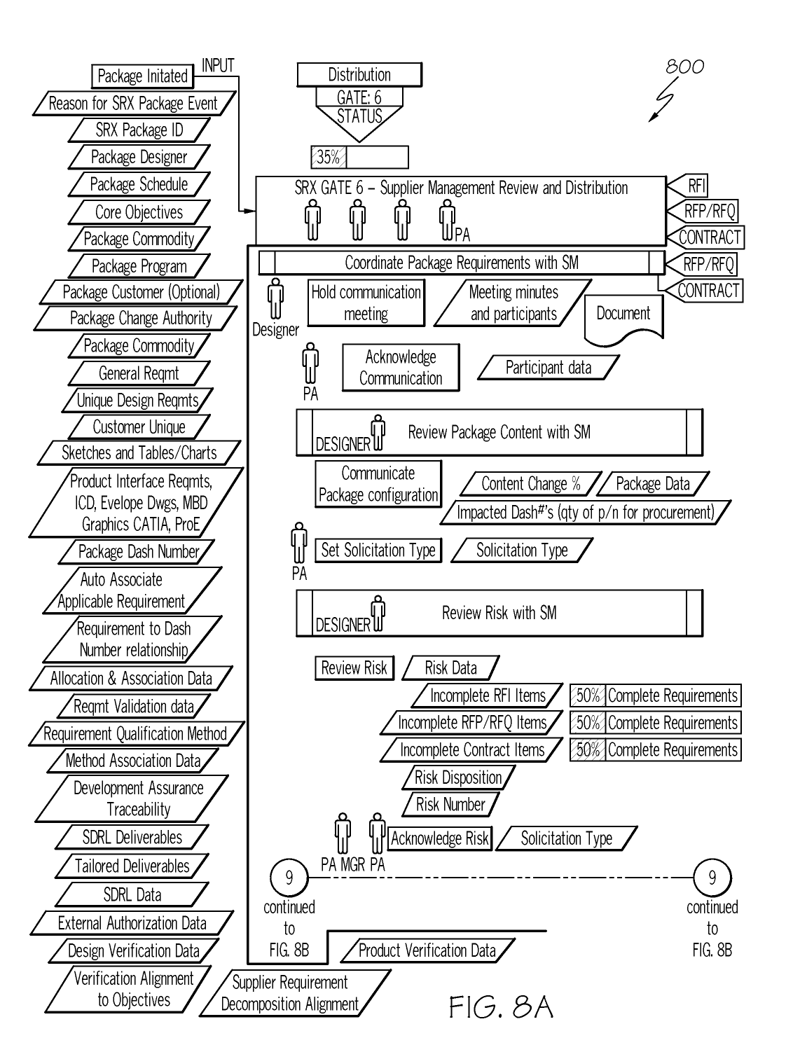

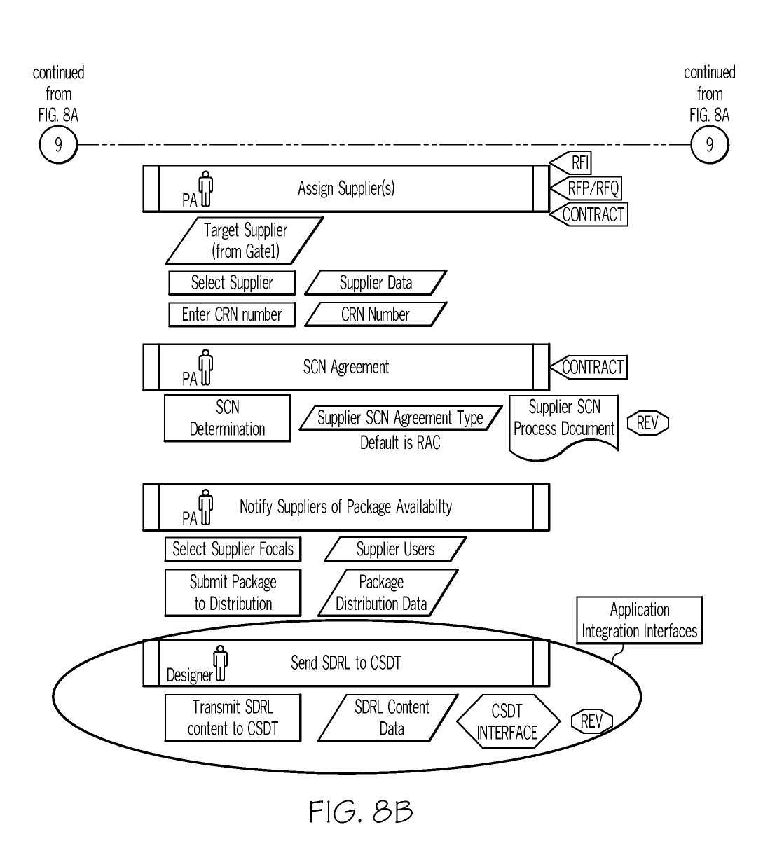

Referring to gated workflow process 800 shown in FIG. 8, gate G6 is directed to Supplier Management Package Review and Supplier Distribution. Industry shows gaps here where the absence of an integrated process and tool for supplier interaction with the source requirements leads to product deficiencies. The workflow process steps in gate G6 tie the creators directly to the supplier designers consuming the requirements without loss of quality of the computer sensible native requirements objects.

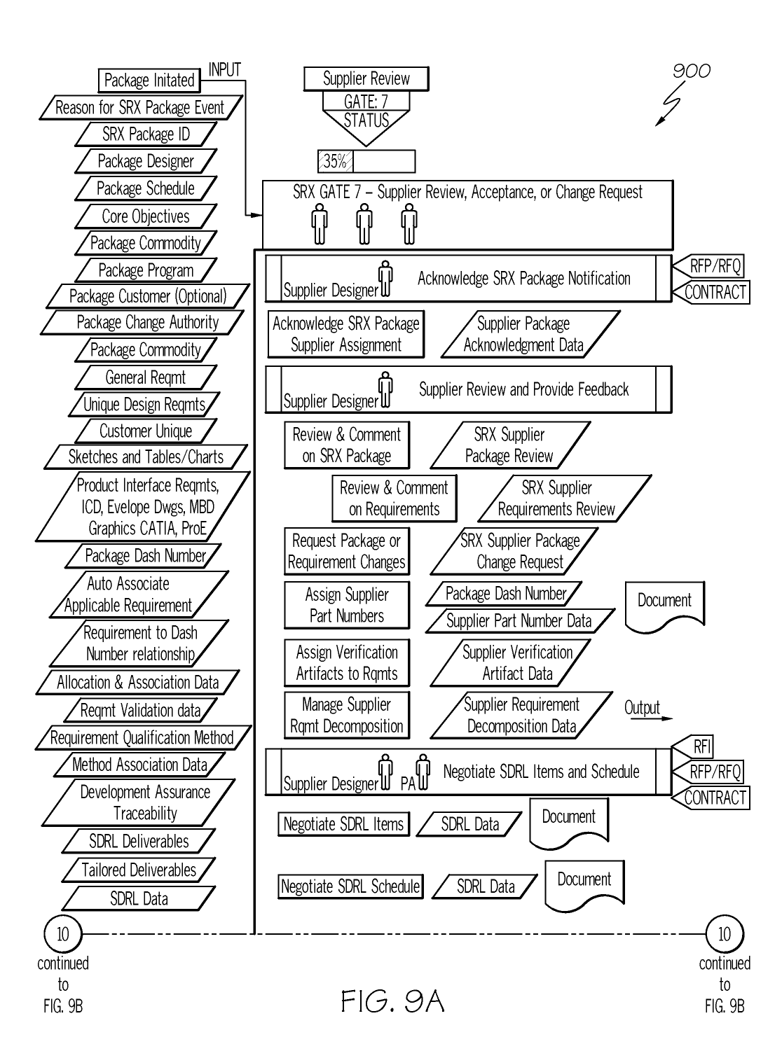

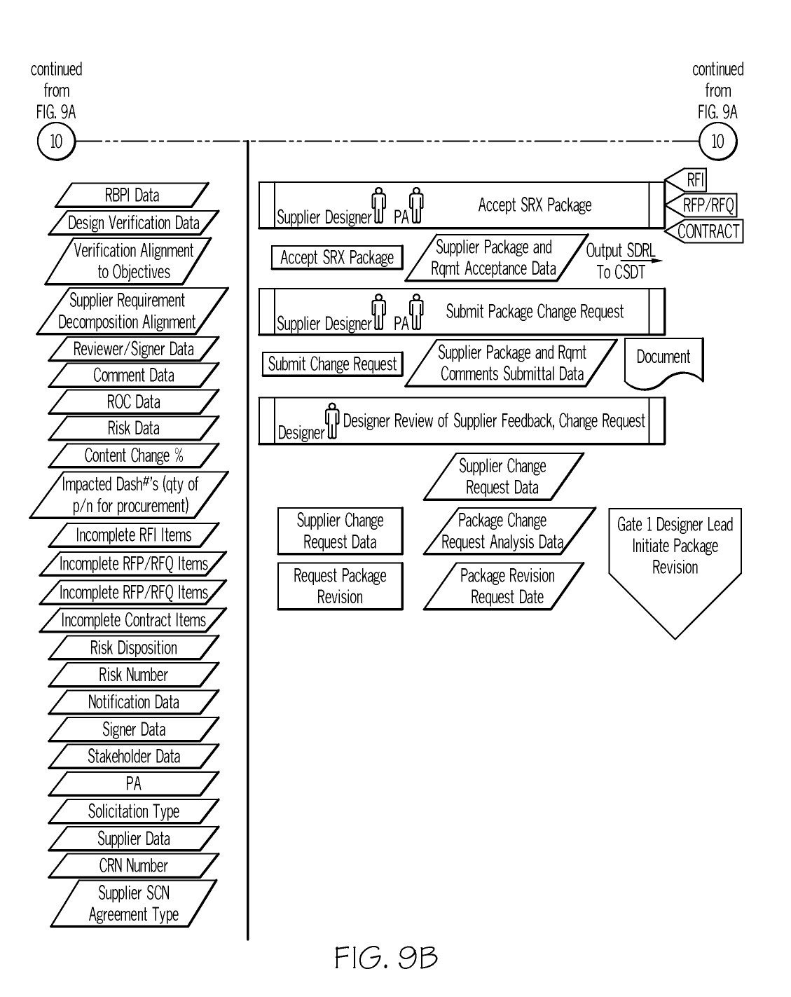

Referring to gated workflow process 900 shown in FIG. 9, gate G7 is directed to Supplier Review, Comment and Acceptance. Gate G7 is focused on supplier review, comment and acceptance of the requirements contract package. Direct access to the source data is unprecedented considering an all in method avoiding any degradation through transfer or conversion of the data to human readable data requiring re-compilation effort and exposing data errors.

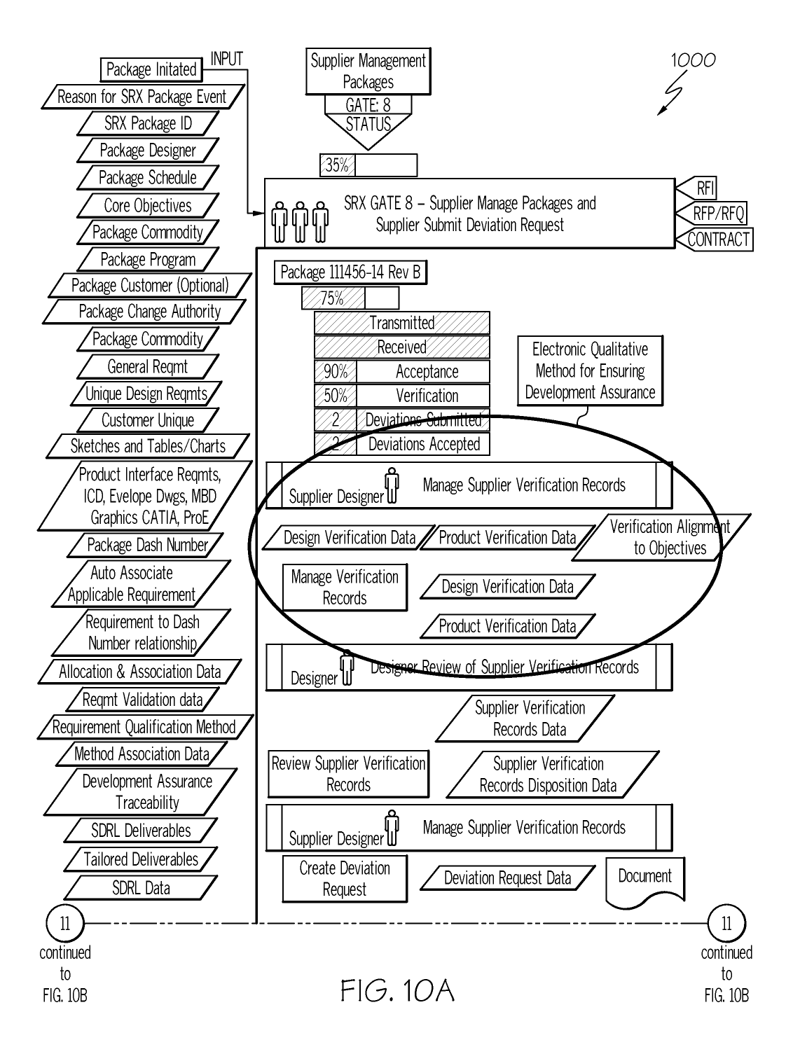

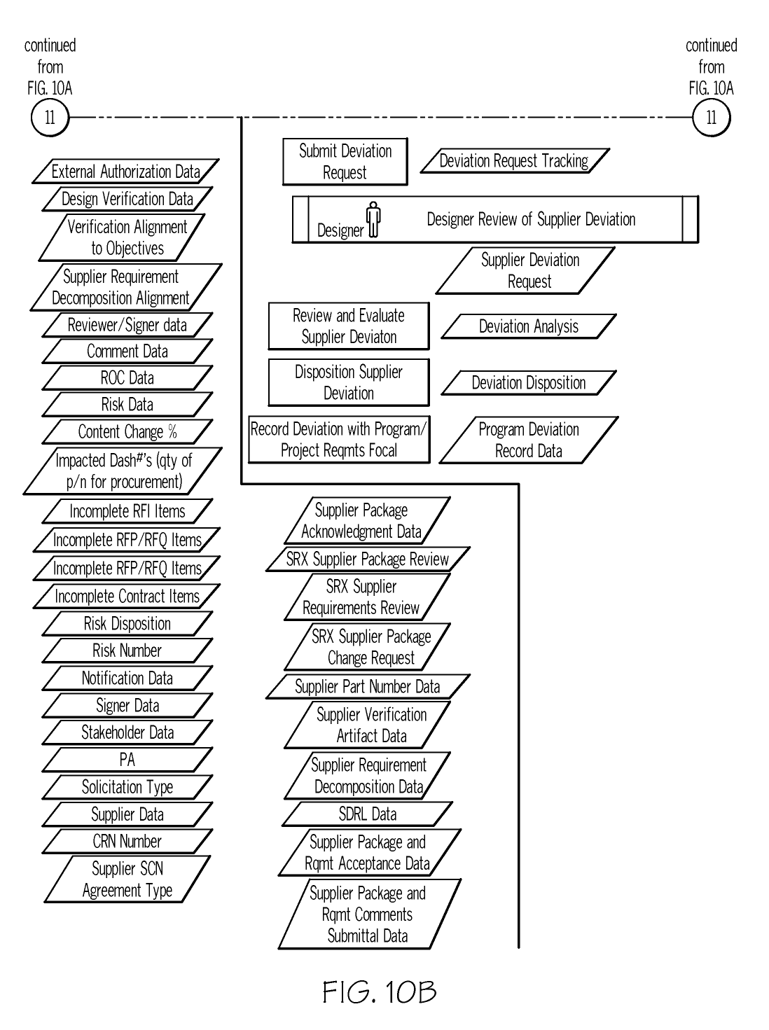

Referring to gated workflow process 1000 shown in FIG. 10, gate G8 is directed to Incorporate Supplier Feedback, Engineering Acceptance of Final Package, and Supplier Package Deviations. Direct access to the source data is unprecedented using an all in method for the receiving party avoiding any degradation through transfer or conversion of the data to human readable data requiring re-compilation effort and exposing data errors. Requirement package deviations are a required record of exception for the defined requirements. These deviations are submitted by the supplier and reviewed by the package author for acceptance. Deviations are critical to the contract and require visibility accordance with regulatory mandate. The historical hazard by industry method kept the deviations disconnected from the source requirements. SRX overcomes the basic instinct for configuration control by carrying the requirements integration for deviations throughout the gated work flow.

The workflow processes 300, 400, 500, 600, 700, 800, 900, and 1000 contained in the eight gates G1, G2, G3, G4, G5, G6, G7, and G8, respectively, described hereinabove provide an SRX tool which includes a number of features described hereinbelow.

A first feature is that the SRX tool comprises an integrated computer sensible single source process and tool which supports electronic design requirements information management utilizing object oriented technology. The implementation of this feature is provided by workflow process steps contained predominately within gate G1.

A second feature is that the SRX tool enables engineering designers to interactively exchange design requirements information with suppliers using a web exchange environment directly from the requirements source. The implementation of this feature is provided by workflow process steps contained predominately within gates G6 and G7.

A third feature is that the SRX tool enables three-way partner business integration, including access permissions, communication, and data distribution. The implementation of this feature is provided by workflow process steps contained predominately within gate G1.

A fourth feature is that the SRX tool provides a method to utilize a gated process workflow for necessary design requirements integration. The implementation of this feature is provided by workflow process steps contained predominately within gate G2.

A fifth feature is that the SRX tool provides an electronic method for supplier input and integration during the gated workflow process supporting requirements development. The implementation of this feature is provided by workflow process steps contained predominately within gate G8.

A sixth feature is that the SRX tool provides an electronic qualitative method for ensuring development assurance regulatory compliance. The implementation of this feature is provided by workflow process steps contained predominately within gates G2, G3, and G8.

A seventh feature is that the SRX tool provides a method to electronically collect, organize, monitor, and manage metrics for the requirements package gated workflow and content. The implementation of this feature is provided by workflow process steps contained predominately within gate G5.

An eighth feature is that the SRX tool provides performance metrics within the context of the object oriented data base for specified levels of granularity. The implementation of this feature is provided by workflow process steps contained predominately within gates G4 and G5.

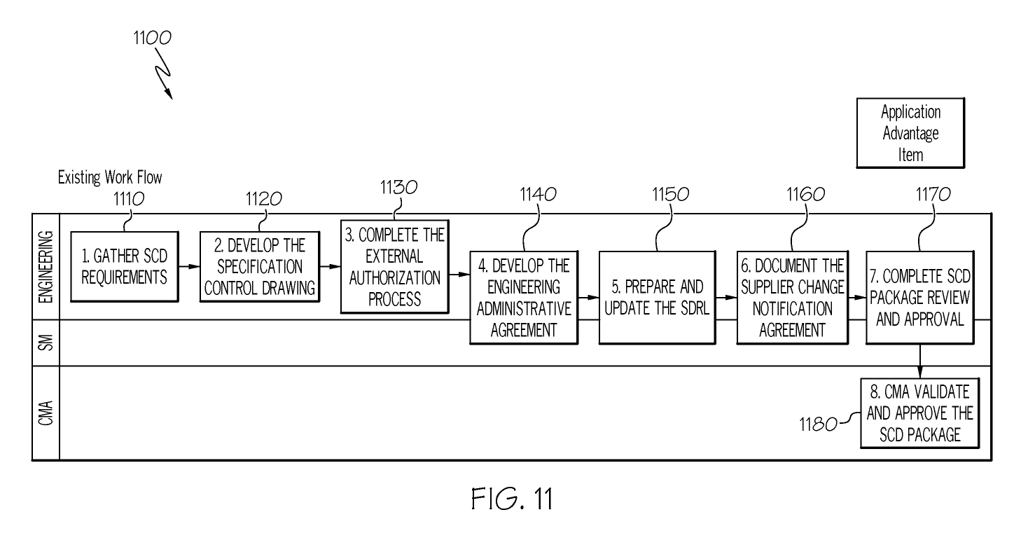

While the workflow process steps contained in each of gates G1-G8 can be understood with reference to FIGS. 3-10, an appreciation of advantages resulting therefrom can be gained by first describing a prior art design requirements off-loading process such as shown in FIG. 11, and designated with reference numeral “1100”. The known design requirements off-loading process 1100 includes workflow process step 1110 in which SCD requirements are gathered, and workflow process step 1120 in which the SCD is developed. The known process 1100 also includes workflow process step 1130 in which an external information release authorization is completed, workflow process step 1140 in which the engineering AA is developed, and workflow process step 1150 in which the SDRL is prepared and updated. The known process 1100 further includes workflow process step 1160 in which the supplier change notification agreement is documented, workflow process step 1170 in which SCD package review and approval is completed, and workflow process step 1180 in which the SCD package is validated and approved by the CMA.

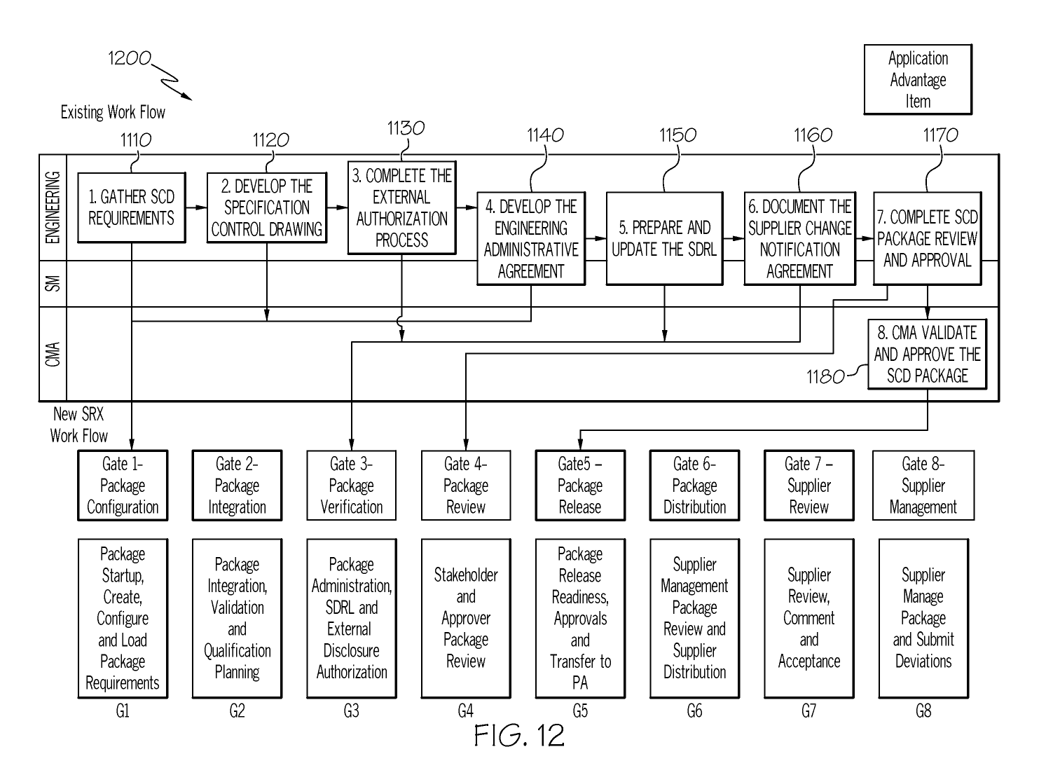

As shown in diagram 1200 of FIG. 12, if the known design requirements off-loading process 1100 of FIG. 11 were to be implemented using the gated workflow processes of G1-G8, then only gates G1, G3, G4, and G5 would be needed. Gates G2, G6, G7, and G8 would not be needed to implement the known design requirements off-loading process 1100 of FIG. 11. Accordingly, the use of gates G2, G6, G7, and G8 fills process gaps in the known process 1100. Thus, the use of gates G2, G6, G7, and G8 provides advantages of package integration (G2), package distribution (G6), supplier acceptance (G7), supplier feedback (G8), and supplier deviations (G8), all of which are absent in the known workflow process 1100.

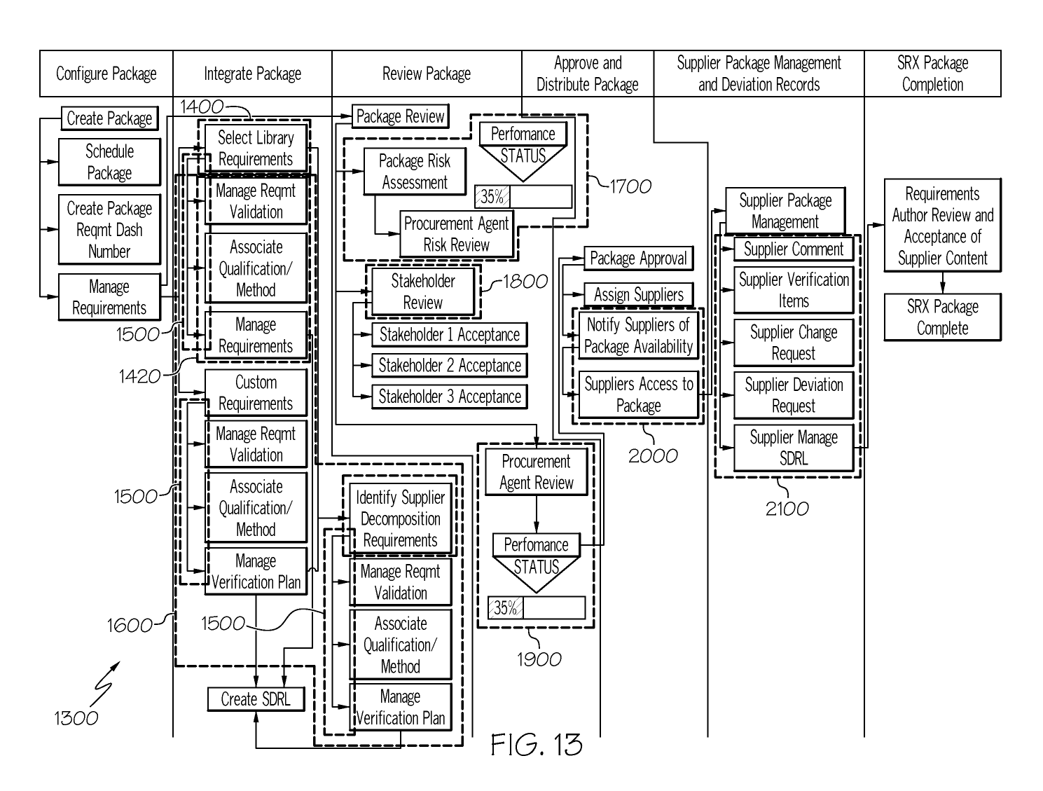

Also, while the workflow process steps contained in each of the individual gates G1-G8 can be understood with reference to the respective figure of FIGS. 3-10, an appreciation of advantages resulting therefrom can be gained by understanding an end-to-end workflow process which transcends gates G1-G8 such as shown in FIG. 13 and designated with reference numeral “1300”.

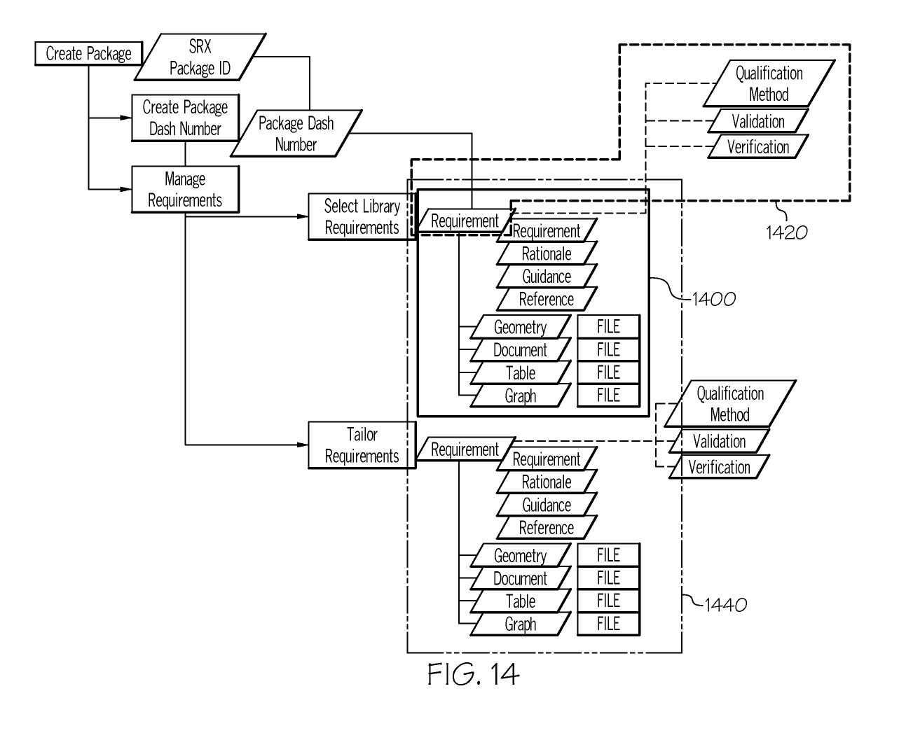

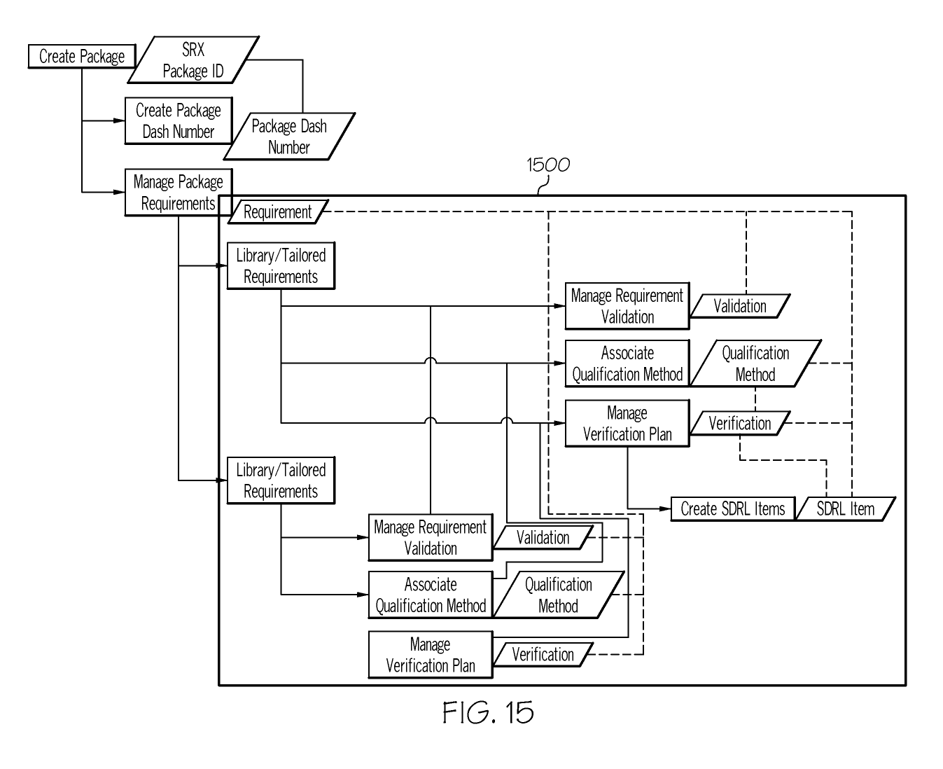

The end-to-end workflow process 1300 shown in FIG. 13 is divided into six functional portions labeled “Configure Package”, “Integrate Package”, “Review Package”, “Approve and Distribute Package”, “Supplier Package Management and Deviation Records”, and “SRX Package Completion”. As shown in FIG. 13, ten highlighted functionalities of the end-to-end workflow process 1300 are indicated by encircled areas. Three of the ten highlighted functionalities are designated by areas 1400, 1420, and 1440 in FIG. 13, and are shown in more detail in FIG. 14. The remaining seven of the ten highlighted functionalities are designated by areas 1500, 1600, 1700, 1800, 1900, 2000, and 2100 in FIG. 13, and are shown in more detail in FIGS. 15, 16, 17, 18, 19, 20, and 21, respectively.

Referring to FIGS. 13 and 14, the functionalities in areas 1400, 1420, and 1440 relate to requirement entities and relationships. More specifically, as shown in area 1400 of FIG. 14, requirements will be managed entities with associations to the supporting elements that make a complete requirement. Also, as shown in area 1420 of FIG. 14, requirements will be associated to qualification method, requirement validation, and supplier requirement verification entities. Further, as shown in area 1440 of FIG. 14, requirements that are created by tailoring an existing requirement will have an association to the original requirement and will maintain associations to supporting elements and qualification method, requirement validation, and supplier requirement verification entities.

Referring to FIGS. 13 and 15, the functionalities in area 1500 relate to system control of required process steps. More specifically, as shown in area 1500 of FIG. 15, system controls recognize when required entities (or elements) are missing or incomplete and directs the user to the required process step to create/complete the required entity.

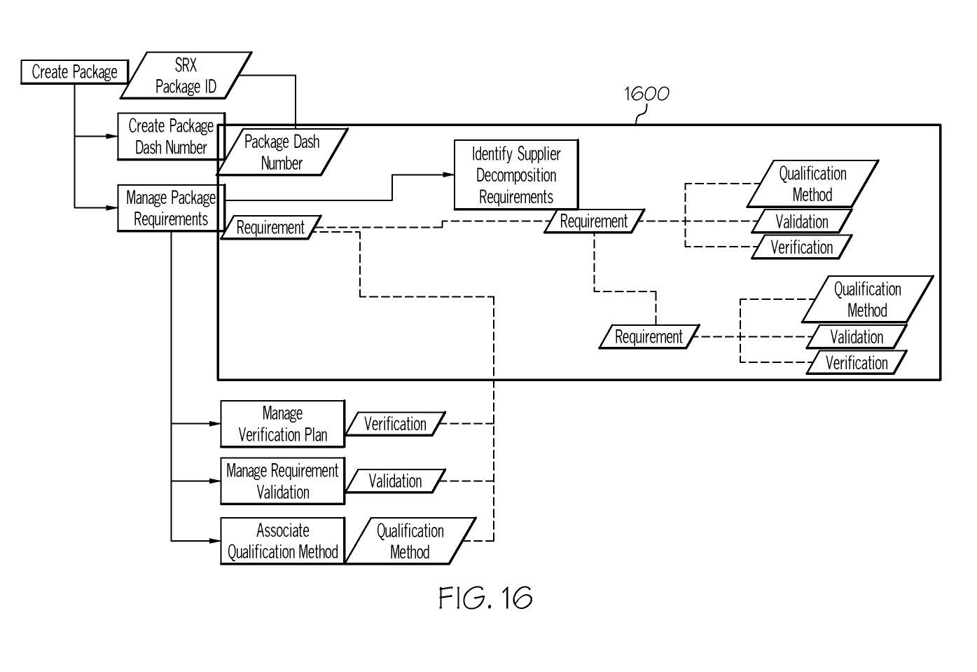

Referring to FIGS. 13 and 16, the functionalities in area 1600 relate to supplier decomposition of requirements. More specifically, as shown in area 1600 of FIG. 16, supplier decomposed requirements are managed maintaining relationships to parent requirements and creating a path for development assurance through traceability of requirements validations, qualification methods, and verifications.

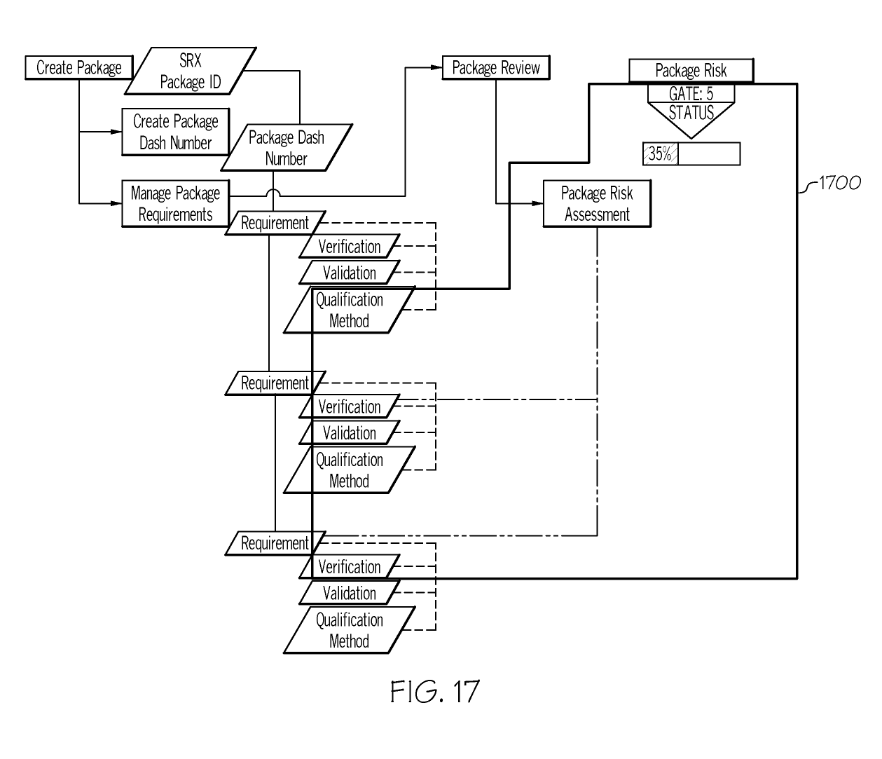

Referring to FIGS. 13 and 17, the functionalities in area 1700 relate to package risk assessment. More specifically, as shown in area 1700 of FIG. 17, the system enables the tracking of relationship and entity completeness and status to create package risk entities identifying specific risks and mitigation plans.

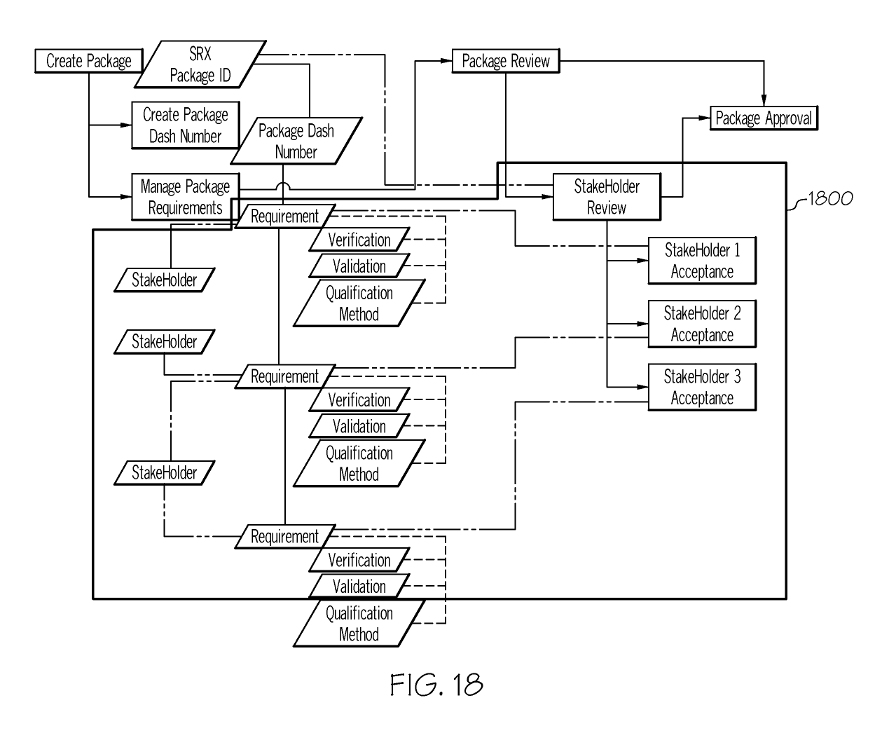

Referring to FIGS. 13 and 18, the functionalities in area 1800 relate to package review with stakeholders. More specifically, as shown in area 1800 of FIG. 18, the system will use relationships between requirements and stakeholders to identify the requirements each stakeholder will review and accept.

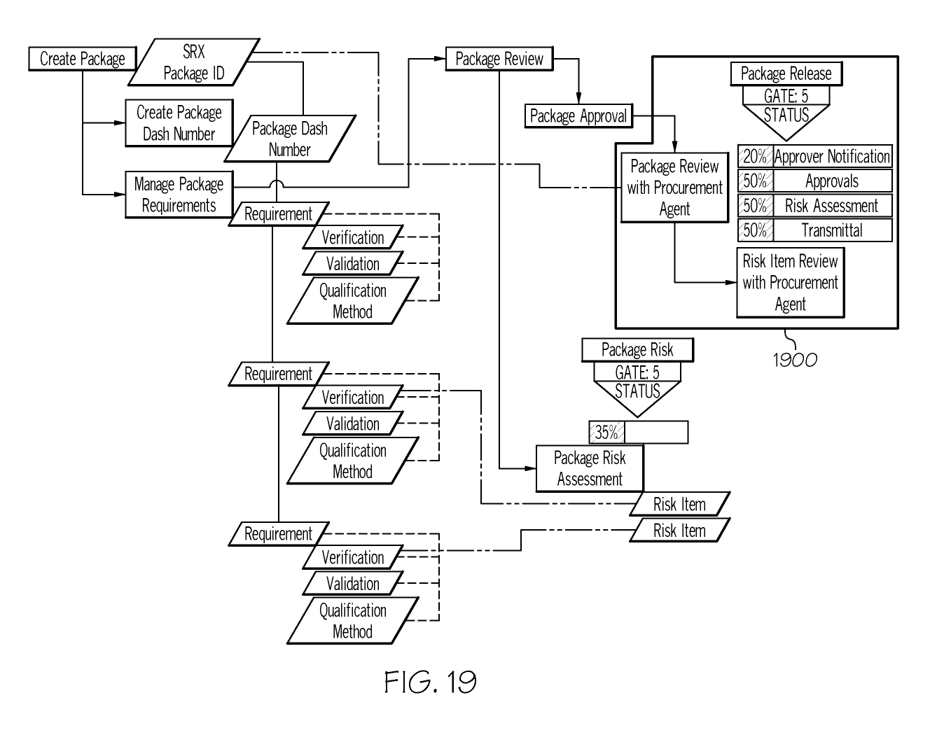

Referring to FIGS. 13 and 19, the functionalities in area 1900 relate to package review with procurement agent. More specifically, as shown in area 1900 of FIG. 19, the system will generate and display metrics based on defined criteria to enable informed decisions about status and schedule.

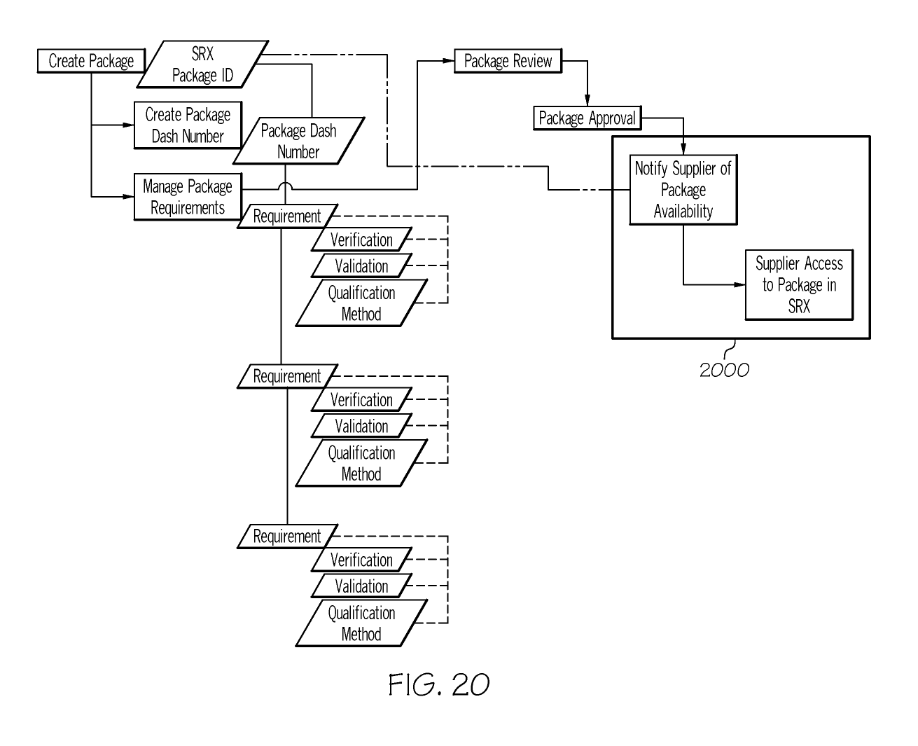

Referring to FIGS. 13 and 20, the functionalities in area 2000 relate to supplier entry into SRX. More specifically, as shown in area 2000 of FIG. 20, SRX will enable supplier entry into the system to operate directly on the package.

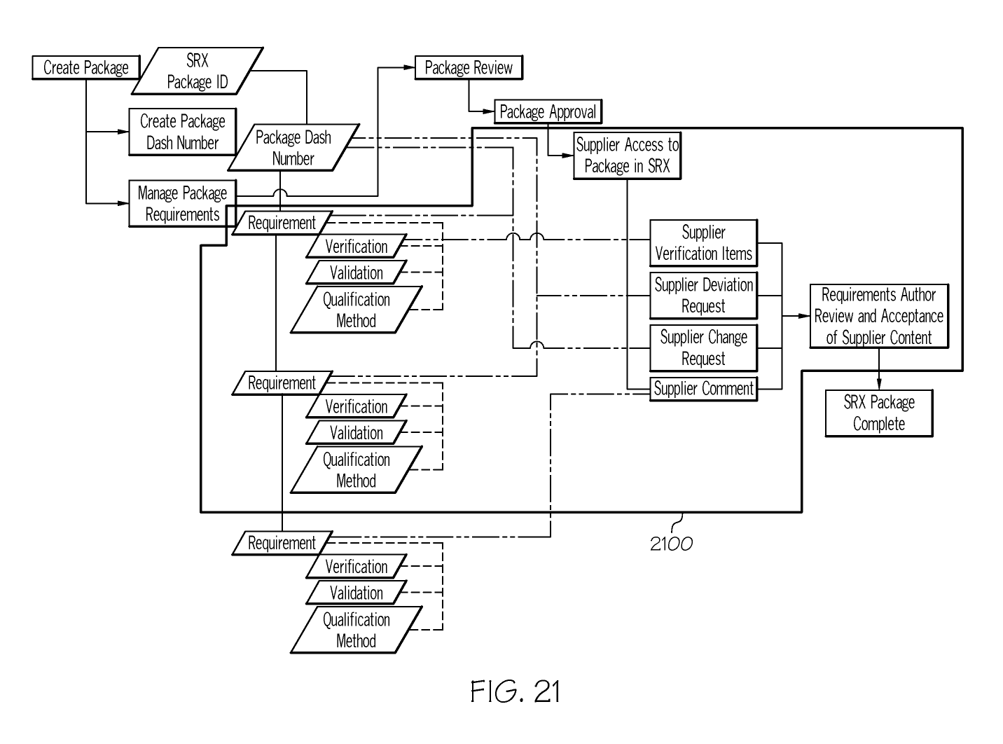

Referring to FIGS. 13 and 21, the functionalities in area 2100 relate to supplier entry into SRX. More specifically, as shown in area 2100 of FIG. 21, the system will enable the supplier to directly link verification items, supplier data requirements list items, deviation requests, change requests, and comments to the specific package elements needing attention. The system will also enable the package author to review and accept the specific items.

The end-to-end workflow process 1300 shown in FIG. 13 and the more detailed workflow process steps shown in FIGS. 14-21 support a number of features including the following:

Provides a method to implement standardized process steps.
Eliminates the need for managing paper SCDs.
Establishes interfaces to source requirement tools.
Allows for collection and storage of requirements data in any electronic format.
Allows all supporting graphic files to remain in original file format.
Controls format within the source files.
Manages user verification and validation activities.
Manages revision control of the requirements packages.
Manages revision control of requirements changes from source tools.
Provides revision notifications.
Eliminates custom distribution behaviors.
Enables suppliers to view information in native file formats.
Provides support for regulatory requirements compliance in the gated process flow.
Allows requirements to be tagged for sub-tier supplier requirements flow down.
Controls storage of requirements validation and verification data, along with completion metrics.
Controls requirements decomposition using hierarchical parent child relationships.
Includes the data necessary to monitor and measure performance during requirements packaging.
Eliminates data duplication and redundancy (as a result of the single source technology). Allows for design requirements package comparisons and reuse.

It should be apparent that the above-described web-based enterprise software system 100 enables the interactive exchange, management, checking, and distribution, of design requirements with suppliers. The web-based system 100 provides a new tool and methods to manage design requirements in an integrated environment while maintaining computer sensibility of design requirements. In particular, the tool and methods enable engineering designers, procurement agents, and suppliers to interactively exchange design requirements during the design requirements off-loading process.

The tool and methods implement an improved standard workflow for design requirements authoring, packaging, distribution and feedback, including metrics and measures which allow performance measurements and reporting during the design requirements development cycle. The improved workflow enables development assurance including requirements validation and verification to be accomplished in accordance with applicable industry regulation, such as Federal Aviation Administration (FAA) regulations for example. The improved workflow also provides an electronic platform for decomposing design requirements and the ability to complete and manage analysis of decomposed design requirements. The improved workflow further enables suppliers to review and comment on design requirements that is integral to the tool and methods.

The improved workflow addresses and resolves a number of problems in known workflows. In particular, the improved workflow addresses known workflow problems of how to package, schedule, communicate, control distribution, monitor performance, and maintain configuration control of the off-load of an engineering part design to a supplier. The improved workflow addresses known lack of compliance controls for industry-required development assurance validation and verification of the design requirements flow down. The improved workflow also resolves the known workflow problems of having multiple data sources by establishing a single source collaborative environment that ensures the integrity of the design requirements and data elements. The improved workflow further addresses the known open loop problem for supplier feedback by providing the capability for suppliers to interactively communicate with engineering designers and procurement agents and thereby to interactively review and comment on design requirements during the design requirements off-loading process.

Aspects of disclosed embodiments may be implemented in software, hardware, firmware, or a combination thereof. The various elements of the system, either individually or in combination, may be implemented as a computer program product tangibly embodied in a machine-readable storage device for execution by a processor. Various steps of embodiments may be performed by a computer processor executing a program tangibly embodied on a computer-readable medium to perform functions by operating on input and generating output. The computer-readable medium may be, for example, a memory, a transportable medium such as a compact disk or a flash drive, such that a computer program embodying aspects of the disclosed embodiments can be loaded onto a computer.

Although the above-description describes a web-based system and method for facilitating a design requirements off-loading process for airplane parts in the aviation industry in accordance with FAA regulation, it is contemplated that the web-based system and method may be implemented to facilitate a design requirements off-loading process for any type of part in any industry in accordance with the applicable industry standards.

Although various aspects of disclosed embodiments have been shown and described, modifications may occur to those skilled in the art upon reading the specification. The present application includes such modifications and is limited only by the scope of the claims.

What is claimed is:

1. A method of operating a web-based system to facilitate interactive exchange and modification of design requirements within a design requirements package between an enterprise and a supplier to the enterprise, the method comprising:
storing, by the enterprise, a design requirements package in an enterprise database;
electronically by a processor, transmitting a message from the enterprise to the supplier to notify the supplier of the availability of the design requirements package stored in the enterprise database; and
accessing, by the enterprise, the design requirements package and supplier deliverables to view modifications made by the supplier to the package after the supplier has been notified of the availability of the package and has accessed the package in the enterprise database and made modifications to the package.

2. The method according to claim 1, further comprising:
identifying, by the enterprise, supplier decomposition requirements within the design requirements package is stored in the enterprise database.

3. The method according to claim 1, wherein modifications made by the supplier to the design requirements package include supplier comments.

4. The method according to claim 1, wherein modifications made by the supplier to the design requirements package include supplier verification items.

5. The method according to claim 1, wherein modifications made by the supplier to the design requirements package include a supplier change request.

6. The method according to claim 1, wherein modifications made by the supplier to the design requirements package include a supplier deviation request.

7. The method according to claim 1, wherein modifications made by the supplier to the design requirements package include a modified supplier deliverable requirements list (SDRL).

8. The method according to claim 1, wherein the method is performed by a computer having a memory executing one or more programs of instructions which are tangibly embodied in a program storage medium readable by the computer.

9. A method of operating a web-based system to facilitate a design engineer and a procurement agent of an enterprise to provide a completed original design requirements package to be off-loaded to a contracted supplier to the enterprise, the method comprising:
creating, by the design engineer, original design requirements;
electronically by a processor, recognizing if required data elements are missing from the original design requirements created by the design engineer;
electronically by a processor, interactively directing the design engineer with process steps needed to provide any required data element missing from the original design requirements and thereby to provide a completed original design requirements package;
storing the completed original design requirements package in an enterprise database; and
reviewing, by the procurement agent, the completed original design requirements package before the contracted supplier is notified of the availability of the completed original design requirements package to allow the contracted supplier to access the completed original design requirements package stored in the enterprise database.

10. The method according to claim 9, wherein creating, by the design engineer, original design requirements includes selecting, by the design engineer, design requirements from a library of requirements.

11. The method according to claim 10, wherein creating, by the design engineer, original design requirements includes identifying supplier decomposition requirements within the design requirements package is stored in the enterprise database.

12. The method according to claim 11, wherein creating, by the design engineer, original design requirements includes creating a supplier deliverable requirements list (SDRL) which contain objects that maintain full traceability for each deliverable.

13. The method according to claim 9, wherein creating, by the design engineer, original design requirements includes tailoring, by the design engineer, an existing design requirements to provide custom requirements.

14. The method according to claim 13, wherein creating, by the design engineer, original design requirements includes identifying supplier decomposition requirements within the design requirements package is stored in the enterprise database.

15. The method according to claim 14, wherein creating, by the design engineer, original design requirements includes creating a supplier deliverable requirements list (SDRL) which contain objects that maintain full traceability for each deliverable.

16. The method according to claim 9, wherein the method is performed by a computer having a memory executing one or more programs of instructions which are tangibly embodied in a program storage medium readable by the computer.

17. A web-based system for facilitating an enterprise to manage design requirements while maintaining computer sensibility of the design requirements during a design requirements off-loading process from the enterprise to a supplier, the web-based system comprising:
an enterprise supplier requirements exchange (SRX) database for storing SRX data;
an executable enterprise SRX application; and
an enterprise host server including a processor configured to execute the enterprise SRX application to enable the supplier to interactively access and modify the SRX data stored in the enterprise SRX database and thereby to facilitate the enterprise in managing the design requirements while maintaining computer sensibility of the design requirements during the design requirements off-loading process.

18. A web-based system according to claim 17, wherein the processor is further configured to recognize if required data elements are missing from original design requirements created by a design engineer of the enterprise.

19. A web-based system according to claim 18, wherein the processor is further configured to interactively direct the design engineer with process steps needed to provide any required data element missing from the original design requirements and thereby to provide a completed original design requirements package.

20. A web-based system according to claim 19, wherein the processor is further configured to transmit a message from the enterprise to the supplier to notify the supplier of the availability of the completed original design requirements package.
